(19) United States
(12) Patent Application Publication
(10) Pub. No.: US 2011/0143657 A1
(43) Pub. Date: Jun. 16, 2011

(54) METHOD OF ESTABLISHING COMMUNICATION LINK BETWEEN A MOBILE EARTH STATION AND A SATELLITE OF MSS AND APPARATUS THEREFOR

(75) Inventors: Hye Mi GAM, Goyang-si (KR); Dae Sub Oh, Daejeon (KR)

(73) Assignee: ELECTRONICS AND TELECOMMUNICATIONS RESEARCH INSTITUTE, Daejeon-city (KR)

(21) Appl. No.: 12/881,529

(22) Filed: Sep. 14, 2010

(30) Foreign Application Priority Data
Dec. 16, 2009 (KR) 10-2009-0125621

(51) Int. Cl. H04B 7/185

(52) U.S. Cl. 455/12.1

(57) ABSTRACT

Provided is an MSS satellite system including a satellite, an ATC and an MES. The satellite transmits a signal of a frequency for FSS to the ATC and transmits a signal of a frequency for MSS to the MES. When the strength of the signal transmitted from the satellite is equal to or greater than a reference value, the MES receives the transmitted signal. When the strength of the signal is less than the reference value, the MES transmits the position coordinates and speed information of the MES together with information transmission request, to the ATC. The ATC applies a beam-forming algorithm by using the position coordinates and speed information of the MES and transmits a directivity-enhanced signal to the MES which requests information transmission.

### CROSS-REFERENCE TO RELATED APPLICATIONS

This application claims priority under 35 U.S.C. §119 to Korean Patent Application No. 10-2009-0125621, filed on Dec. 16, 2009, in the Korean Intellectual Property Office, the disclosure of which is incorporated herein by reference in its entirety.

### TECHNICAL FIELD

The following disclosure relates to a Mobile Satellite Service (MSS) satellite system using Ancillary Terrestrial Component (ATC) and a communication link establishing method thereof, and in particular, to an MSS satellite system and a communication link establishing method thereof, which can improve power efficiency.

### BACKGROUND

An MSS satellite communication can be used without communication disconnection between the MES and the satellite by accessing a Mobile Earth Station (MES) through an ATC and allowing the MES to communicate with a satellite via the ATC even at an area where link between the MES and the satellite is weakened by artificial obstacles or topography.

Referring to FIG. 1, in an MSS satellite system, stations 131 to 135 communicate with a satellite 110 through link. However, at an area where link with the satellite 110 is weakened by ambient obstacles, the MSS satellite system secures link between the satellite 110 and an ATC 120 and the ATC 120 transmits a signal to each of the MESs 131 to 135, thereby establishing a communication link between the satellite 110 and the MESs 131 to 135.

This is a method that can prevent communication disconnection between the satellite 110 and the MESs 131 to 135, but interference is caused by that in which the satellite 110 and the ATC 120 transmit the signals of the same frequency, and much power is consumed in the signal transmission of the ATC 120.

### SUMMARY

In one general aspect, a method for a Mobile Earth Station (MES) to establish a communication link to a satellite, in a Mobile Satellite Service (MSS) satellite system including the satellite, an Ancillary Terrestrial Component (ATC) and the MES, comprises: measuring a strength of a first signal from the satellite; establishing a first communication link to the satellite, when a strength of the first signal is equal to or greater than a predetermined reference value; transmitting an information transmission request to the ATC, when the strength of the first signal is less than the reference value; receiving a second signal, to which a beam-forming algorithm is applied by the ATC, from the ATC; and establishing a second communication link to the satellite disposing the ATC between the satellite and the MES, when the second signal is received.

The method may further include transmitting position coordinates and speed information of the MES to the ATC, when the strength of the first signal is less than the reference value, wherein the beam-forming algorithm is applied using the position coordinates and the speed information.

The first and second signals may have the same frequency, and the frequency is a frequency which is allocated for MSS.

In another general aspect, a method for an Ancillary Terrestrial Component (ATC) to relay a communication link for a Mobile Earth Station (MES) to a satellite, in a Mobile Satellite Service (MSS) satellite system including the satellite and the MES, comprises: receiving a first signal from the satellite; applying a beam-forming algorithm to the first signal to make a second signal having a directionality; and transmitting the second signal to the MES.

The method may further comprises receiving an information transmission request from the MES, wherein the information transmission request includes position coordinates and speed information of the MES, and wherein the beam-forming algorithm is applied using the position coordinates and speed information of the MES. It is preferable that the frequency of the second signal is different from that of the first signal.

In another general aspect, An Ancillary Terrestrial Component (ATC) for establishing communication link between a satellite and a Mobile Earth Station (MES), in a Mobile Satellite Service (MSS) satellite system, is characterized in that: the ATC receives a first signal of a first frequency from the satellite, applies a beam-forming algorithm to the first signal to make a second signal having a directionality, and transmits the second signal of a second frequency to the MES to allow the MES to receive the second signal instead of a signal transmitted from the satellite.

Here, the first frequency is a frequency allocated for Fixed Satellite Service (FSS) while the second frequency is a frequency allocated for MSS.

In another general aspect, a Mobile Earth Station (MES) establishing communication link to a satellite, in a Mobile Satellite Service (MSS) satellite system comprising an Ancillary Terrestrial Component (ATC) and the satellite, is characterized in that: the MES requests information transmission to the ATC when a strength of a first signal transmitted from the satellite is less than a predetermined reference value and receives a second signal from the ATC in response to the information transmission request, wherein the second signal has a directionality to the MES as a result of an application of a beam-forming algorithm by the ATC.

The MES may receive the first signal instead of the second signal when the strength of the first signal is equal to or greater than the reference value. The second signal has a same frequency as that of the first signal. The MES may request information transmission to the ATC when the strength of the second signal is less than the reference value.

Other features and aspects will be apparent from the following detailed description, the drawings, and the claims.

### BRIEF DESCRIPTION OF THE DRAWINGS

FIG. 1 is a schematic diagram illustrating the configuration of a related art MSS satellite system.

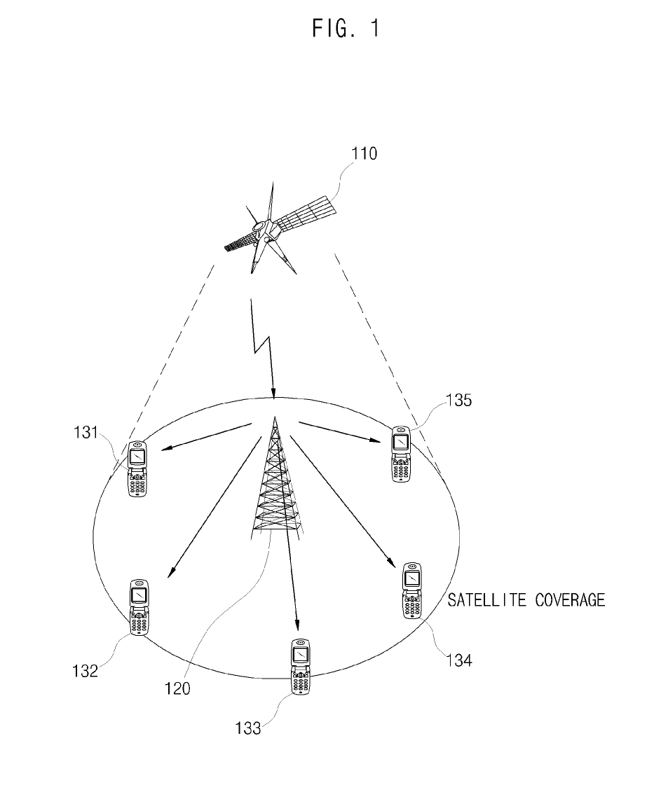

FIG. 2 is a schematic diagram illustrating the configuration of an MSS satellite system according to an exemplary embodiment.

FIG. 3 is a flow chart illustrating a communication link establishing method in satellite communication system according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

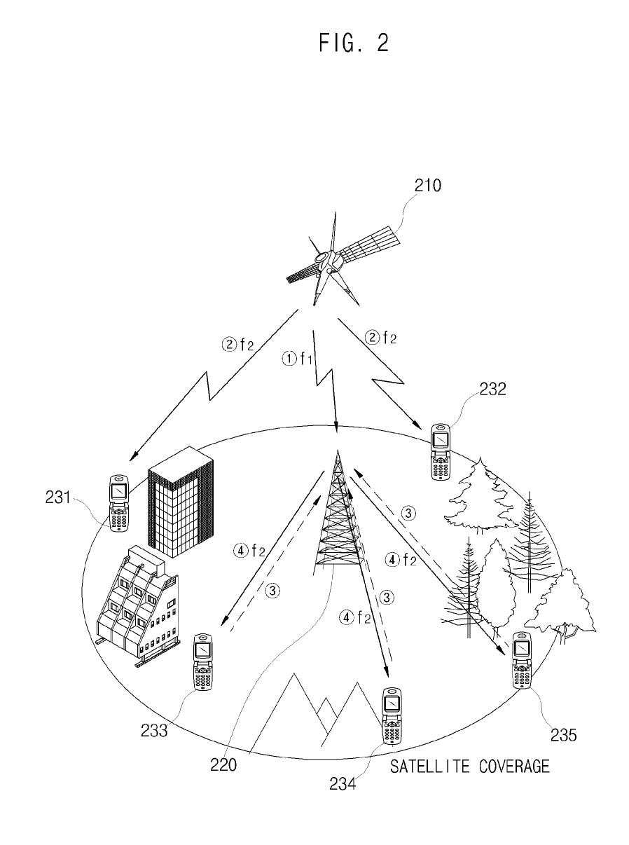

FIG. 2 is a diagram illustrating the configuration of a Mobile Satellite Service (MSS) satellite system according to an exemplary embodiment.

Referring to FIG. 2, an MSS satellite system according to an exemplary embodiment includes a satellite 210 which is a space station, an Ancillary Terrestrial Component (ATC) 220, and a plurality of Mobile Earth Stations (MES) 231 to 235.

Communication service provided to the MESs 231 to 235 is fundamentally provided through the satellite 210.

For this, the satellite 210 transmits information through two paths \textcircled{1} and \textcircled{2}. The path \textcircled{1} is one through which the satellite 210 transmits information to the ATC 220, and the other path \textcircled{2} is one through which the satellite 210 transmits information to the MESs 231 to 235. In a case \textcircled{1} where the satellite 210 transmits information to the ATC 220, the satellite 210 uses a frequency ‘f1’ this is divided for Fixed Satellite Service (FSS). In a case \textcircled{2} where the satellite 210 transmits information to the MESs 231 to 235, the satellite 210 uses a frequency ‘f2’ that is divided for MSS.

The ATC 220 receives a signal that is transmitted from the satellite 210 in operation \textcircled{1} and again transmits the received signal to each of the MESs 233 to 235 in operation \textcircled{4}. A signal that the ATC 220 receives from the satellite 210 is the signal of a frequency ‘f1’ in operation \textcircled{1}. Unlike this, when the ATC 210 transmits a signal to each of the MESs 233 to 235, it transmits the signal with a frequency ‘f2’ which is the same frequency as that of a case where the ATC 210 transmits information to each of the MESs 231 to 235 in operation \textcircled{4}.

Each of the MESs 231 to 235 receives the signal of the frequency ‘f2’ that is transmitted from the satellite 210.

At this point, the MESs 231 and 232 among the MESs may receive the signal of a frequency ‘f2’, which is transmitted from the satellite 210, with sufficient strength in operation \textcircled{2}. Accordingly, a communication link between the MESs 231 and 232 and the satellite 210 is directly established between the satellite 210 and the MESs 231 and 232.

On the other hand, the MESs 233 to 235 among the MESs may not receive a frequency ‘f2’ signal of sufficient strength in communication due to ambient topography or artificial obstacles. The MESs 233 to 235 receive a signal which is transmitted from the satellite 210 to the ATC 220 in operation \textcircled{1} and again is transmitted from the ATC 220 in operation \textcircled{4}. At this point, a communication link between the MESs 233 to 235 and the satellite 210 is established in a state where the ATC 220 is disposed between the MESs 233 to 235 and the satellite 210.

For this, each of the MESs 233 to 235 which does not receive the signal of sufficient strength from the satellite 210 requests information transmission to the ATC 220 in operation \textcircled{3}. Each of the MESs 233 to 235 is called a desired MES.

Each of the desired MESs 233 to 235 transmits its own position coordinates and speed information together with information transmission request, to the ATC 220.

The ATC 220 checks the accurate position and speed of each of the desired MESs 233 to 235 by using the position coordinates and the speed information that is included in the information transmission request that is received from the desired MESs 233 to 235. The ATC 220 transmits a directivity-enhanced signal to the desired MESs 233 to 235 through a beam-forming antenna to which a digital beam-forming algorithm is applied, for transmitting a signal to the desired MESs 233 to 235 without giving interference to an adjacent station other than the desired MESs 233 to 235. As one scheme used for smart antennas, herein, beam forming refers to a technology that allows the beam of an antenna to be restrictively irradiated only to a target station. For example, a scheme such as beam division multiple access may be used.

In this way, the ATC 220 using the same frequency as that of the satellite 210 uses a beam-forming technology for transmitting a signal to the desired MESs 233 to 235, and thus directivity in desired direction can be enhanced and interference given to an adjacent station can be reduced. Moreover, since a beam-forming antenna forms a desired signal pattern through signal processing, an ATC can adaptively operate in a complicated satellite communication environment. An adaptive transmission scheme applying the beam-forming algorithm of an ATC increases power efficiency and thereby enables to operate more systems at the same power. A feature, which lowers interference probability by decreasing power consumption and enhancing spatial directivity, can be used for improving the reused rate of a frequency in a satellite communication environment in which a frequency resource is insufficient.

Hereinafter, a communication link establishing method in satellite communication system according to an exemplary embodiment will be described in detail.

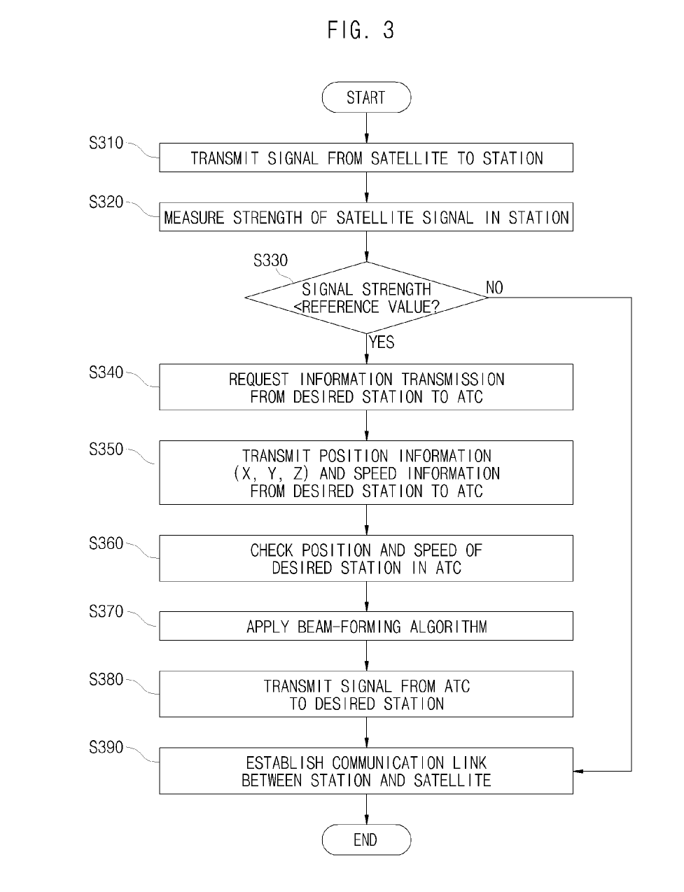

FIG. 3 is a flow chart illustrating a communication link establishing method in satellite communication system according to an exemplary embodiment.

Referring to FIG. 3, when the satellite 210 transmits a signal to the MESs 231 to 235 in operation S310, each of the MESs 231 to 235 receiving the signal measures the strength of a satellite signal in operation S320.

When the strength of the satellite signal is equal to or greater than a reference value in operation S330, a communication link between the satellite 210 and the MESs 231 and 232 is established in operation S390.

When the strength of the satellite signal is less than the reference value in operation S330, the desired MESs 233 to 235 request information transmission to the ATC 220 in operation S340. After requesting information transmission, the desired MESs 233 to 235 transmit position coordinates and speed information to the ATC 220 in operation S350. Herein, although operation S340 of requesting information transmission and operation S350 of transmitting the position coordinates and the speed information are illustrated as separate operations, the position coordinates and the speed information may be transmitted together with information transmission request from each of the desired MESs 233 to 235 to the ATC 220.

The ATC 220 receiving the position coordinates and the speed information checks the position and speed of each of the desired MESs 233 to 235 in operation S360, and consequently, a suitable beam-forming algorithm is applied in operation S370. A signal to which the beam-forming algorithm is applied is transmitted from the ATC 220 to the desired MESs 233 to 235 in operation S380, and thereby a communication link between the desired MESs 233 to 235 and the satellite 210 is established in a state where the ATC 220 is disposed between the desired MESs 233 to 235 and the satellite 210.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for a Mobile Earth Station (MES) to establish a communication link to a satellite in a Mobile Satellite Service (MSS) satellite system including the satellite, an Ancillary Terrestrial Component (ATC), and the MES, the method comprising:
measuring a strength of a first signal from the satellite;
establishing a first communication link to the satellite, when a strength of the first signal is equal to or greater than a predetermined reference value;
transmitting an information transmission request to the ATC, when the strength of the first signal is less than the reference value;
receiving a second signal, to which a beam-forming algorithm is applied by the ATC, from the ATC; and
establishing a second communication link to the satellite disposing the ATC between the satellite and the MES, when the second signal is received.

2. The method of claim 1, further comprising transmitting position coordinates and speed information of the MES to the ATC, when the strength of the first signal is less than the reference value,
wherein the beam-forming algorithm is applied using the position coordinates and the speed information.

3. The method of claim 1, wherein the first and second signals are signals having the same frequency.

4. The method of claim 3, wherein the frequency is a frequency which is allocated for MSS.

5. A method for an Ancillary Terrestrial Component (ATC) to relay a communication link for a Mobile Earth Station (MES) to a satellite in a Mobile Satellite Service (MSS) satellite system including the satellite and the MES, the method comprising:
receiving a first signal from the satellite;
applying a beam-forming algorithm to the first signal to make a second signal having a directionality; and
transmitting the second signal to the MES.

6. The method of claim 5, further comprising receiving an information transmission request from the MES.

7. The method of claim 6, wherein the information transmission request includes position coordinates and speed information of the MES.

8. The method of claim 7, wherein the beam-forming algorithm is applied using the position coordinates and speed information of the MES.

9. The method of claim 5, wherein:
the first signal has a first frequency; and
the second signal has a second frequency different from the first frequency.

10. The method of claim 9, wherein:
the first frequency is a frequency which is allocated for Fixed Satellite Service (FSS); and
the second frequency is a frequency which is allocated for MSS.

11. An Ancillary Terrestrial Component (ATC) for establishing communication link between a satellite and a Mobile Earth Station (MES) in a Mobile Satellite Service (MSS) satellite system, characterized in that:
the ATC receives a first signal of a first frequency from the satellite, applies a beam-forming algorithm to the first signal to make a second signal having a directionality, and transmits the second signal of a second frequency to the MES to allow the MES to receive the second signal instead of a signal transmitted from the satellite.

12. The ATC of claim 1, wherein:
the first frequency is a frequency which is allocated for Fixed Satellite Service (FSS); and
the second frequency is a frequency which is allocated for MSS.

13. The ATC of claim 11, wherein the ATC receives an information transmission request from the MES.

14. The ATC of claim 13, wherein the information transmission request includes position coordinates and speed information of the MES.

15. The ATC of claim 14, wherein the beam-forming algorithm is applied using the position coordinates and speed information of the MES.

16. The ATC of claim 13, wherein the ATC transmits the second signal in response to the information transmission request.

17. A Mobile Earth Station (MES) establishing communication link to a satellite in a Mobile Satellite Service (MSS) satellite system comprising an Ancillary Terrestrial Component (ATC) and the satellite, characterized in that:
the MES requests information transmission to the ATC when a strength of a first signal transmitted from the satellite is less than a predetermined reference value and receives a second signal from the ATC in response to the information transmission request,
wherein the second signal has a directionality to the MES as a result of an application of a beam-forming algorithm by the ATC.

18. The MES of claim 17, wherein the MES receives the first signal instead of the second signal when the strength of the first signal is equal to or greater than the reference value.

19. The MES of claim 18, wherein the second signal has a same frequency as that of the first signal.

20. The MES of claim 19, wherein:
the MES transmits position coordinates and speed information of the MES to the ATC; and
the beam-forming algorithm is applied using the position coordinates and the speed information.
